(19) United States
(12) Patent Application Publication
(10) Pub. No.: US 2010/0318520 A1
(43) Pub. Date: Dec. 16, 2010

(54) SYSTEM AND METHOD FOR PROCESSING COMMENTARY THAT IS RELATED TO CONTENT

(75) Inventors: Shoshana K. Loeb, Philadelphia, PA (US); David Famolari, Stewartsville, NJ (US)

Correspondence Address: TELCORDIA TECHNOLOGIES, INC., ONE TELCORDIA DRIVE 5G116, PISCATAWAY, NJ, 08854-4157, US

(73) Assignees: Telecordia Technologies, Inc., Piscataway, NJ (US); Kabushiki Kaisha Toshiba, Tokyo (JP)

(21) Appl. No.: 12/786,640

(22) Filed: May 25, 2010

Related U.S. Application Data
(60) Provisional application No. 61/182,860, filed on Jun. 1, 2009.

(51) Int. Cl. G06F 17/30; G06F 15/16

(52) U.S. Cl. 707/743; 709/219; 707/754; 707/E17.014; 707/E17.11

(57) ABSTRACT

A system and method for processing commentary that is related to content is provided. In an illustrative embodiment, the system and method involves receiving commentary that is related to content and which is generated after generation of the content, and generating data associating the commentary with the content by at least one of spatially linking the commentary to the content or temporally linking the commentary to the content.

### CROSS-REFERENCE TO RELATED APPLICATION

The present application claims benefit of U.S. Provisional Application No. 61/182,860, filed Jun. 1, 2009, the disclosure of which is hereby incorporated by reference herein.

### BACKGROUND OF THE INVENTION

The proliferation of devices capable of receiving media content has increased people's access to content. For example, people may now watch broadcast video on their cell phones. Moreover, the proliferation of intelligent devices capable of receiving content has increased the number of ways in which people access content. For example, people may use their home computer to view video programming in one “window” while simultaneously editing a text in a second “window.”

### SUMMARY OF THE INVENTION

It has been recognized that the proliferation of intelligent devices capable of receiving media content has created an environment in which commentary related to content may be processed in a manner that enhances the user experience. Accordingly, the present system and method for processing commentary that is related to content is provided. In an illustrative embodiment, the system and method involves receiving commentary that is related to content and which is generated after generation of the content, and generating data associating the commentary with the content by at least one of spatially linking the commentary to the content or temporally linking the commentary to the content.

### BRIEF DESCRIPTIONS OF THE DRAWINGS

The following detailed description given by way of example, but not intended to limit the invention solely to the specific embodiments described, may best be understood in conjunction with the accompanying drawings wherein like reference numerals denote like elements and parts, in which:

FIG. 1 is block diagram of an embodiment of a system for receiving and providing user-created commentary associated with media content.

FIG. 2 is block diagram of one alternative embodiment of a system for receiving and providing user-created commentary associated with media content.

FIG. 3 is a block diagram of an embodiment of a system for receiving and providing user-created commentary associated with media content, the commentary being provided by multiple users and being accessible by multiple users.

FIG. 4 is a functional block diagram showing how a service provider processes received commentary in accordance with an embodiment.

FIG. 5 is a functional block diagram showing how a service provider processes a request for commentary in accordance with an embodiment.

### DETAILED DESCRIPTION

Prior to describing the present system and method in detail, it is noted that the terms “content” and “commentary” are used in the description and claims to refer to any information that may be stored in electronic form. For example, content and commentary includes audio, video, images, text, hypertext links, and graphics. Further, it is noted that the term “content” may refer to a single “content,” such as an image, or multiple “contents,” such as two images. Still further, it is noted that the term “commentary” may refer to a single “comment,” such as a line of text, or multiple “comments,” such as a line of text and an audio track.

In an embodiment, a system for processing commentary that is related to content is provided. The system includes at least one server for receiving commentary that is related to content and which is generated after generation of the content, and for generating data associating the commentary with the content by at least one of spatially linking the commentary to the content or temporally linking the commentary to the content.

The system may also include a storage for storing the commentary and the data apart from the content.

The data may include at least one of an identity of a person who created at least a portion of the commentary, a time of day associated with creation of the commentary, a day of the week associated with creation of the commentary, or a tag descriptive of the commentary.

The at least one server may be used for receiving requests for the commentary.

The at least one server may be used for receiving requests for commentary and providing commentary in response to the requests.

The at least one server may be used for receiving a request for commentary, filtering the commentary according to criteria provided with the request to generate filtered commentary, and providing the filtered commentary in response to the request.

The at least one server may be used for receiving a relative location within the content for at least a portion of the commentary.

The at least one server may be used for receiving a user ID indicative of an identity of a person who created at least a portion of the commentary.

In an embodiment, a method for processing commentary that is related to content is provided. The method includes receiving commentary that is related to content and which is generated after generation of the content, and generating data associating the commentary with the content by at least one of spatially linking the commentary to the content or temporally linking the commentary to the content.

The method may include storing the commentary and the data apart from the content.

The data may include at least one of an identity of a person who created at least a portion of the commentary, a time of day associated with creation of the commentary, a day of the week associated with creation of the commentary, or a tag descriptive of the commentary.

The method may include receiving requests for the commentary.

The method may include providing at least a portion of the commentary in response to requests.

The method may include receiving a request for commentary, filtering the commentary according to criteria provided with the request to generate filtered commentary, and providing the filtered commentary in response to the request.

The method may include receiving a relative location within the content for at least a portion of the commentary.

The method may include receiving a user ID indicative of an identity of a person who created at least a portion of the commentary.

In an embodiment, a device for receiving content and commentary, and for presenting the received content and commentary to a user is provided. The device includes at least one interface for receiving the content from a first source and receiving the commentary from a second source, and a processor for performing at least one of spatially linking the commentary to the content or temporally linking the commentary to the content.

The at least one interface may include a first interface for receiving the content from a first source, and second interface for receiving the commentary from a second source.

The at least one interface may be used for receiving data for at least one of spatially linking the commentary to the content or temporally linking the commentary to the content.

The device may present the content with the commentary overlaying the content in a manner specified by the data.

The device may include at least one input for allowing the user to indicate that only comments that appear within a specified region of the content should be presented.

The device may include at least one input for accepting at least one of user-generated commentary concerning the content or user-generated feedback concerning the content.

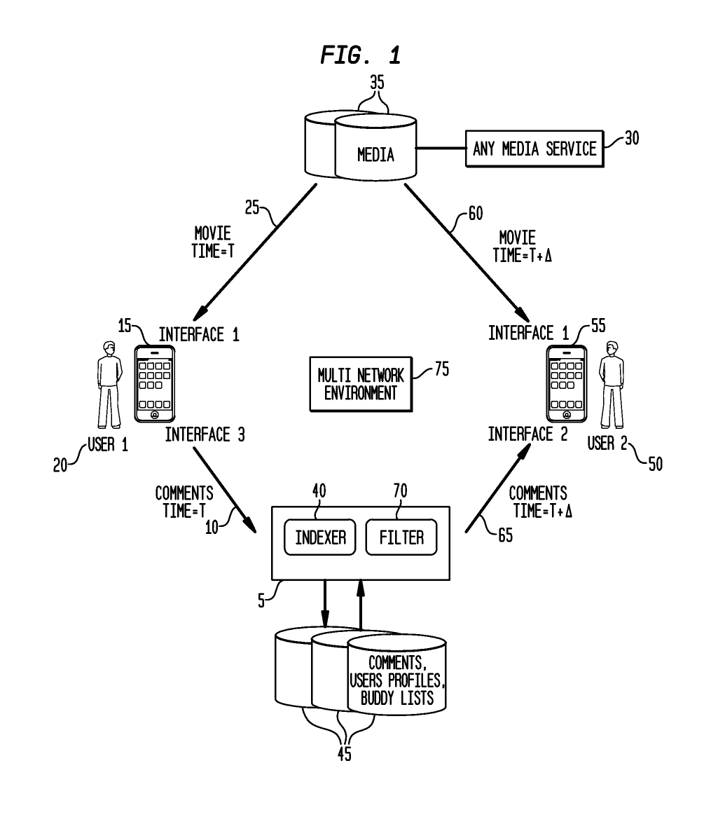

Having described some illustrative embodiments, reference is now made to FIG. 1.

FIG. 1 is block diagram of an embodiment of a system for receiving and providing user-created commentary associated with media content. As can be seen from the figure, the system includes a server 5 that receives commentary 10 from a mobile device 15 (e.g. a cell phone). More specifically, the mobile device is used by a first user 20 to view content 25 provided to the mobile device, and the user generates the commentary 10 while viewing the content by activating inputs on the device. The content is provided to device 20 from a media service 30, the media service being associated with a database 35 in which the content is stored.

When server 5 receives the commentary, it employs and indexer 40 to associate metadata with the commentary and then stores the commentary and associated metadata in a database 45. Examples of metadata that may be associated with the commentary include the name of the person who created the commentary, comment numbers, and the name of an associated content file.

The commentary stored in database 45 may be retrieved by a second user 50. In one embodiment, the second user may request the viewing of content and associated commentary through a mobile device 55 (e.g. a cell phone). In such embodiment, requested content 60 is delivered to mobile device 55 from media service 30, and requested commentary 65 is delivered to mobile device 55 from server 5. The content and commentary received at device 55 is presented to user 50 through device 55.

In some embodiments, server 5 may employ a filter 70 to filter commentary provided to device 55 in accordance with criteria included in a request received from device 55. For example, a request may specify that only text comments for requested content 60 are to be supplied to device 55, in which case filter 70 will filter out any non-text comments associated with content 60.

In any event, the presentation of the requested content and requested commentary on device 55 are synchronized. That is, the content and commentary are spatially and/or temporally synchronized during presentation to user 50. For instance, when the commentary includes an audio comment concerning a particular content image, the user will hear the audio comment when the particular content image is displayed. For this purpose, synchronization data linking the commentary to the content, spatially and/or temporally, may be included with requested commentary 65, the synchronization data being used by device 55 to synchronize the commentary with the content.

The system of FIG. 1 operates in a multi-network environment 75. Each of devices 15 and 55 has multiple network interfaces, with one interface used to handle content and another interface used to handle commentary. Accordingly, for each device the flow of content to/from the device is independent of the flow of commentary to/from the device.

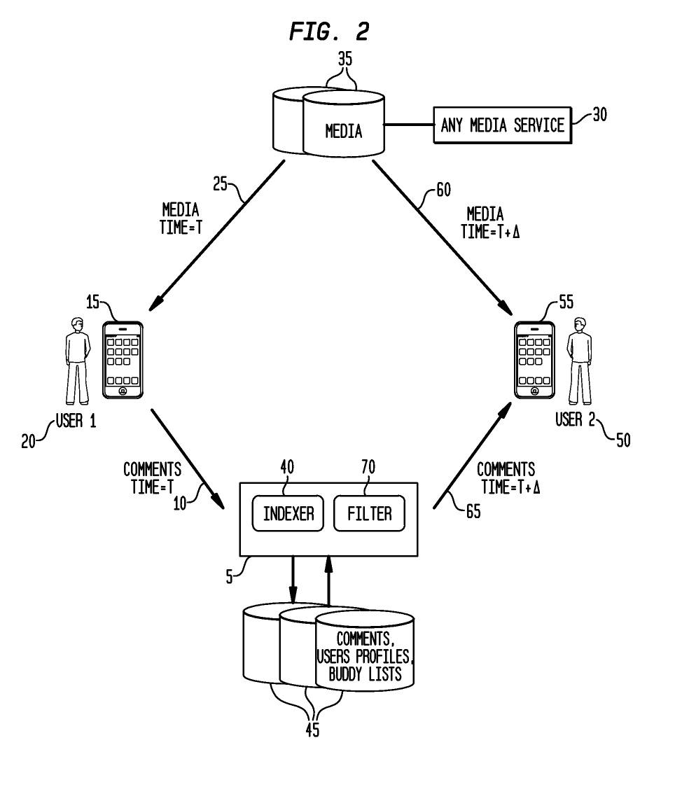

By contrast, FIG. 2 shows a system operating in a traditional network. The system of FIG. 2 works in a manner similar to that of FIG. 1, with the exception that each of devices 15 and 55 has a shared interface for the reception/transmission of both content and commentary.

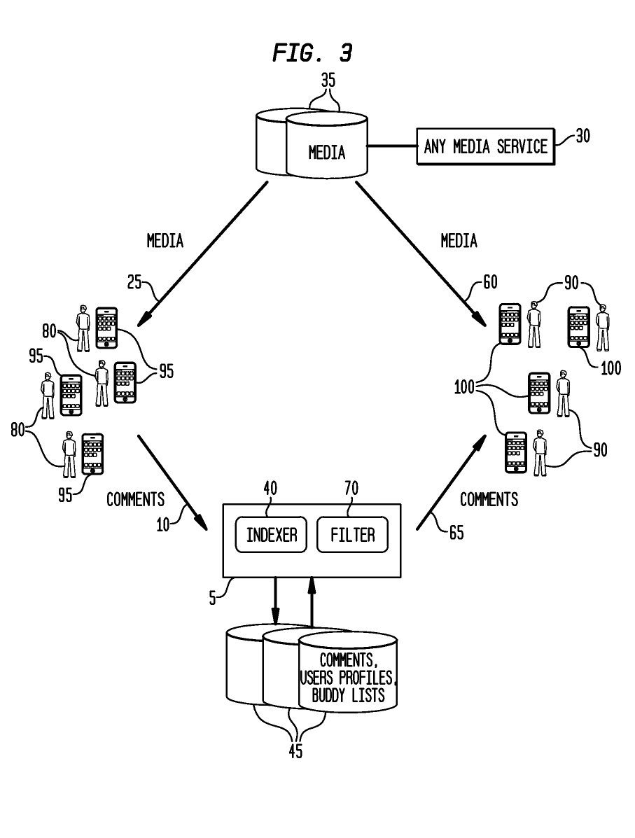

FIG. 3 is a block diagram highlighting the social networking aspects of the systems of FIG. 1 and FIG. 2. As can be seen from FIG. 3, commentary 10 may be provided by multiple users 80 and is accessible by multiple users 90. In the depicted embodiment, users 80 may receive content 25 and provide commentary 10 via respective mobile devices 90, and users 90 may receive content 60 and commentary 65 via respective mobile devices 100. The figure depicts the embodiment as implemented in a traditional network environment like that shown in FIG. 1; however, the embodiment may also be implemented in a multi-network environment like that shown in FIG. 2.

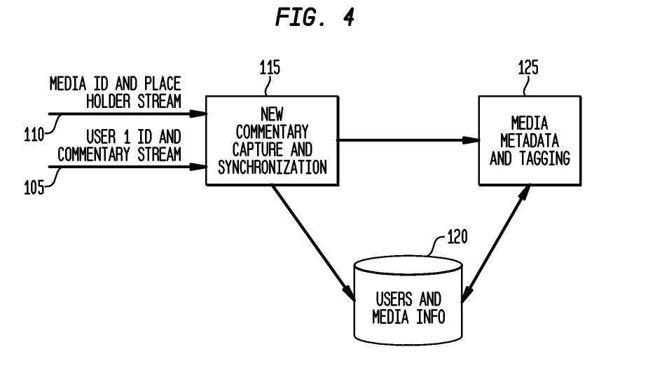

Referring now to FIG. 4, there is shown a functional block diagram of an embodiment for processing received commentary. In order to facilitate an understanding of how FIG. 4 relates to the other figures, one may consider the embodiment of FIG. 4 as performing functions similar to server 5 and database 45 of FIG. 1. That is, the embodiment of FIG. 4 performs the functions of receiving generated commentary, indexing the received commentary, and storing the indexed commentary. In FIG. 4, a commentary is received with a User ID, a Media ID, and a place holder (collectively “commentary data”). The User ID identifies the user who generated the commentary. The Media ID identifies the content to which the commentary relates. The place holder indicates the spatial location of the commentary relative to the content. Further, it should be noted that the commentary may include one or more timestamps that temporally link the commentary to the related content.

In FIG. 4, the commentary data is received as a first stream 105 and a second stream 110. The first stream includes the commentary and User ID, and the second stream includes the Media ID and place holder. The two streams are received via respective interfaces. In an alternative embodiment, the commentary data may be received as a single stream via a single interface. Regardless, the commentary data undergoes a “New commentary capture and synchronization” process 115. In this process data necessary for synchronizing the commentary and content is collected and such synchronization data is stored in a “Users and Media Info” database 120. For example, process 115 provides place holder and timestamp data to database 120.

In addition, an output of process 115 undergoes a “Media metadata and tagging” process 125. In process 125 metadata and tagging data is generated and associated with the commentary such that commentaries provided by different users may be distinguished, and such that comments that make up the commentaries may be distinguished from each other, whether or not such comments are provided by a multiple of users. The output of processes 125 is stored in database 120. Further, process 125 accesses database 120 for purposes of performing the “metadata and tagging” functions. For instance, process 125 may access database 120 to retrieve information relating to the user who created a particular comment and tagging that comment with such information.

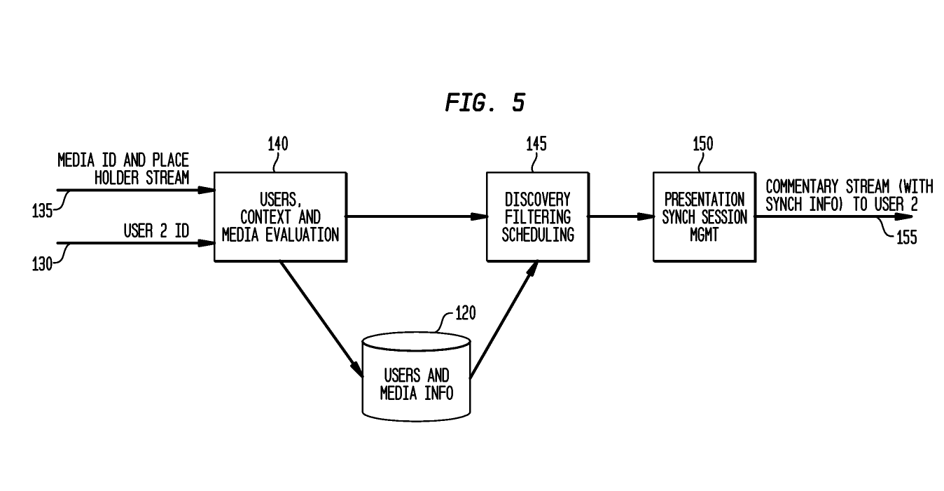

The information stored in database 120 may be accessed by users wishing to view commentary concerning an identified content. In one embodiment, a user requests commentary. In another embodiment, a user is notified that commentary is available and is offered and opportunity to accept or decline viewing of the commentary. FIG. 5 is a functional block diagram of an embodiment for processing a request for commentary.

As can be seen from FIG. 5, a request for commentary may include a User ID 130 and a Media ID and place holder 135. In an alternative embodiment, a place holder is not included in the request for commentary. When a place holder is included, it may be used by a requesting user to specify commentary appearing within a region having a particular spatial relationship to the underlying content.

In the FIG. 5 embodiment, the User ID 130 and Media ID and place holder 135 are received via respective interfaces. In an alternative embodiment, the User ID 130 and Media ID and place holder 135 may be received via a single interface. Regardless, the User ID 130 and Media ID and place holder 135 are passed to a “Users, context and Media Evaluation” process 140. In this process the identity of the requesting user is determined from the User ID and the identity of the content for which the user seeks commentary is identified from the Media ID. The content identity determined in block 140 is then used as a cross-reference for flagging corresponding commentary from database 120. The flagged commentary is subjected to a “Discovery Filtering Scheduling” process 145.

In process 145, commentary is selected from among flagged commentary through application of user-specified criteria. Such user-specified criteria may be stored in database 120 and retrieved from the database by using User ID 130 as a cross-reference. Upon retrieval of the user-specified criteria, process 145 compares the criteria to metadata for the flagged commentary. When, for a given flagged commentary, the criteria matches the metadata to a predetermined extent, it is determined that the given flagged commentary should be supplied to the user. Further, the user-specified criteria may indicate a scheduled time for presentation of the desired content, in which case corresponding scheduling of the supply of commentary is implemented by process 145.

Once process 145 has determined the commentary to be delivered and has scheduled the delivery of such commentary, process 145 initiates a “Presentation Synch Session Mgmt” process 150. Process 150 provides the commentary to the user in the form of a commentary stream 155 that is synchronized spatially and/or temporally with the corresponding content. Process 150 works by matching spatial and temporal coordinates associated with the selected commentary to the underlying content. That is, by monitoring the playout time of the underlying content process 150 can track when commentary should be presented, and by tracking the spatial coordinates of visual comments process 150 can insure that such comments are spatially overlaid on the underlying content in the manner intended by the commentator.

Having provided a description of embodiments in connection with FIGS. 1-5, additional embodiments and additional description of FIGS. 1-5 is now provided.

The embodiments discussed in reference to FIGS. 1-5 and the additional embodiments concern personalized mobile multimedia services, social media services, multi-interface mobile device, multi stream services, user generated content, social networks, and collaborative information services. The embodiments solve the problem of creating shared, rich, time-shifted, connected-media experiences. Current online media applications and methods for viewing social media are all too often serialized. For example, you can watch a YouTube, then scroll down and read user comments about that video. No mechanism currently exists to provide overlayed user-generated comments synchronized to media playback. By contrast, the present embodiments include a system and method to allow users to generate comments that can be spatially and temporally linked to online media. The embodiments may further include a distribution system that allows these user-generated comments to be made available to a user's social network and to other users of the system. The resulting system provides end users with a richer media experience that allows them to experience both the underlying media and the overlayed comments in synchronicity, thus providing greater temporal and spatial context for the comments.

The described embodiments allow users to leave messages/commentary for friends. Further, commentary left by friends for us in the past and could either be stored centrally by a service provider or displayed in an variety of ways including running commentary (such as what exists on DVDs today when they include directors commentary) or the user can be notified about an upcoming commentary via an icon on the screen and choose to select it or not. The architecture and mechanisms address the capturing management delivery and rendering of user generated commentary in a social networking application environment and without modification to the original media.

The embodiments differ from mechanisms to provide director's trailing comments on DVDs, teacher's comments on instructional material and the like. One difference could be that the present solution addresses DYNAMIC and on-the-fly commentary based on user's choice as represented by an explicit request or a stored profile. The embodiments provide a means of dynamically embedding, associating, distributing and rendering user-generated comment objects into an information stream from a plurality of sources in a social networking context.

Regarding commentary creation and viewing “in context,” it is noted that the embodiments may involve two groups of users. The first group consists of users that create commentary while consuming streaming media. Their commentary may relate to the specific location in the media in which it is created or the piece of media as a whole or to fragments of it. The second group of users while consuming that same media can selectively (based on individual and collaborative profiles and other filtering mechanisms) access commentary left by the first group and consume the commentary in the appropriate parts of the media streams. Any individual user can take part in both groups—creating the commentary and consuming it. Furthermore, a user can create commentary while consuming commentary of others.

In the present system, the original (uncommented) media is stored unmodified as part of a media service, and the user generated commentary is stored in the Personalized Commentary Service which is depicted at the bottom of the figures above and which has been denoted as “the service”.

FIGS. 1-5 depict three of the many use cases for the service. In a scenario that may be implemented according to FIG. 1 the following steps are described:

Step 1: user 1 creates commentary to the media he/she consumes at time T.

Step 2: The commentary created in step 1, without the original media but with reference to it, is then interpreted by the Indexer which is part of the service's platform. The commentary and the meta data are then stored in a database and can be accessed either immediately or later by any user that either selected to do so and had the right access permissions.

Step 3: User 2 chooses to consume the same original media from a media service.

Step 4: User 2 realizes either by accessing the personalized commentary serviceor by being notified by it (“pull” or “push”), that there are commentary available for this media. The matching between user 2 and the available commentary is done by Information Filters that looks at the profile of user 2 or at his query (“I want to see any comments that Jerry Sienfeld left for this movie”, or “show me the most watched commentary for this documentary”, or “always show me comments that are funny” or “I would like the fashion commentary on these CNN broadcast” etc). User 2 then consumes the media and commentary at time T+Δ. Note that Δ is equal 0 in cases where the commentary production and consumption happens (almost) simultaneously—e.g., where user 1 provides commentary for user 2 in real time while consuming the same media.

It should be noted that comments are individually addressable, personalized, and searchable, indexable, and tagged. Comments can be shared with a social network. Filtering techniques can be applied to make available comments more manageable. Comments are atomic units that can be delivered on their own. Social networking aspects. Multiple comments can be displayed across multiple commentators. Comments are synchronized. On-the-fly assembly. Shared media experience. comments can tracked back to the commentator.

Some further aspects of the way user 2 interacts with the comments and navigates in the space of comments are described in fuller detail in the sections that follow:
The user interfce for user 2 may allow for skipping to the next comment—may include skipping to just before next comment so that viewer can get the media context for that comment.
The user can provide his/hers rating to the commentary—thumbs up/down, liked, ratings, re-comment.
Comments can be linked to other comments—tags can relate to other tags in different reference media. Through a chain of linked comments, one could navigate through (and discover) the world's best sports highlights, or the best subscriber network interface (SN1) kits for example. (hyperlinking in web analogized to video, audio and other media). Here the media experience is driven and navigated by tagged sub-content and users absorb related scenes across many different reference media.
The user controls the look and feel of the comments as some can be announced through audio, through graphic overlays, etc. This is all specified by the user profile preferences as well as by the availability of the commentary in that form.
Comments can be visualized according to groups of related comments. Comments from one user can be in yellow, comments from another user can be green, etc.
Comments can be disabled and re-abled at any point.
One of the real time streaming mechanism for the comments can be really simple syndication (RSS), a publish subscribe mechaism or polling model to incorporate the real-time commentary.
Trackback technologies can be used so that commentators know how many times their comments have been integrated into media and been viewed.

Also note that in the simplest use case, the “commentary” can be a pre-stored and fixed—e.g., subtitiles in different langauages that can be overlayed on a movie coming from a “generic” streaming movie source.

In the case depicted in FIG. 1 we also show the network access to the media and commentary. As shown, the users consume the media and commentary on their smart mobile device and that if the mobile device support multiple network interfaces (e.g., as guided by the 802.21 standard) then the delivery of the multimple media streams (original media and commentary) can be done independently on each of the network interfaces and then mashed up and synchronized on the device for display to the user. In this case the device is running an application that takes care of the display of multiple information streams and the session management as is discussed further below.

In FIG. 2 the same case is depcited but without the multiple network interfaces. In this case the device will be running a different version of the mashup and synchronization session management application.

In FIG. 3 a multiple user scenario is shown, where both the creation of commentary and the consumption of the original media and the commentary are performed by a social group as described above.

Additional details are now provided for the following aspects of the embodiments:
Commentary production
Commentary distribution
Commentary filtering
Commentary rendering
Service initiation for commentary creation and comsumption

Commentary Creation/Production

Comments are produced by users in response to consuming pieces of media. Media may be digital audio, video, a slideset presentation, a document and any other forms of electronic media. One embodiment is a commentary production environment that is integrated into standalone media player. Another embodiment involves a commentary production environment that constitutes a web-browser plug-in. Other embodiments are envisioned and the above serves only has an illustrative set.

For purposes of illustration, consider the use case of a user watching a video in a media player. Other use cases are possible and this use case is simply representative. The media player contains an application environment called the Commentary Production Environment (CPE). The CPE is an editable space where a user can input text, graphics, hyperlinks, emoticons and other artifacts. The user will be able to modify the appearance of the artifacts by changing their fonts, colors, spacings, etc. The environment can be a what-you-see-is-what-you-get (WYSIWYG) type environment or it could be a scripting environment. Either modes are possible.

Discrete captures of the current state of the CPE and its contents are called comment events (CE), or simply comments. A user marks the creation of a comment event (CE) by explicitly publishing the content of the CPE by clicking a ‘Publish’ or ‘Write’ or ‘Send’ or ‘Comment’ button.

The CPE is time synchronized to the playing media. Once a user indicates the completion of a comment by clicking ‘Publish’ (or takes other appropriate actions), the resulting comment is packaged, tagged and associated with the current timeline of the playing media. Each comment then is a self contained code entity that may contain text, graphics, hyperlinks, etc. that also contains a timestamp that links it to the particular point in time during the media playout when it was created. Also, the comment may contain spatial information about where the commentator intends to place the comment relative to the underlying media. For example, commentator can create a “thought bubble” comment containing a graphic and some text, and that comment may be placed spatially above a character's head in the underlying media. Additionally, each comment contains meta-data associated with it such as the identity of the commentator, the time of day, day of week and year the comment was created, and any other tags that the commentator may wish to associate with the comment. For example, the commentary may choose to tag a comment as “funny”, or “family”, etc. The names of the tags are completely at the discretion of the commentator.

A commentator may make multiple such comments while consuming a single piece of media. In this case, a series of comments will be associated with the media. Because comments are self-contained pieces of code that include timestamp information, the media player application can replay comments in-synch with the original media and thus recreate an enriched media experience. Because the comments are separate from the media, unique media experiences can be tailored for different users by overlaying combinations of comments on top of the underlying media.

Users who watch reference media can then choose to view subsets of available comments inline with the media. This provides a unique and rich user experience that is unique. Viewers can see how their friends reacted to certain parts of a movie. Advertisers can place hyperlinks to featured products in TV shows that link to product pages. Communities can form around a shared media experience that is more interactive and engaging. The activity is social and can be limited a user's base of social networking contacts and friends. The activity can be instructional where additional information can be displayed alongside content, for example hyperlinks to user manuals and training resources can be displayed during a technical demonstration. Links to downloadable recipes can be displayed during cooking shows. With VoIP technology, placeholders can be displayed to remind viewers to place calls at specific points in time during the media playback (votes for American Idol, etc.). An infinite number of other examples exist.

Comments are indexed, tagged, separable and searchable. Each comment is indexed to the reference media (the media on which the commentator commented), the time of creation, the identity of the commentator, and any tags the commentator chose to associate with the comment. Each comment is self-contained and distinct, therefore it can be separated from other comments the commentator may have made while watching the same reference media. As such, comments are searchable along many dimensions.

Comments may be transmitted and stored in a network server. This makes it possible to share comments across users. Additionally comments may be aggregated into commentary files associated with reference media. Commentary files may be stored locally or stored remotely.

A third party may choose to watch reference media for which one or more comments or commentary files exist.

Because comments are separable, the third party may mix comments from different commentators and have those comments integrated into their media experience. Additionally, the third party may search for, and pull in, comments that contain certain tags.

Commentary Distribution and Filtering

Comments can be stored locally or on network servers. They may be distributed via a number of online syndication and distribution techniques like RSS/ATOM (Any Transport over a Multiprotocol Label Switching backbone), etc. They may also be specifically searched for by users. Users may search by keyword, comment generator, tags or other elements. Users may also filter comments based on comment media type (text, audio, video, graphics, etc.).

The system includes a social networking aspect that automatically makes comments generated by a user's social network available.

The system will allow users view comment-enriched media to provide feedback on each individual comment. A simple system of feedback would include a binary like/no-like indication. Thus if a user found a particular comment interesting, he/she could indicate that with a simple mouse click, keystroke, etc. A richer feedback system would allow users to provide rankings to each comment on a numeric scale. A still richer feedback system would allow users to append comments to comments. In this realization, comments-to-comments would grow and travel with the original comment so that subsequent viewers of the original comment could see the trail of user feedback and engage in the discussion.

Comments may also be collaboratively filtered. For example, a user may decide to only subscribe to the most popular comments for a particular media. The most popular designation would be for comments that were rated the highest by the user community. Users could also choose to view the most commented-on comments. These comments are the ones that generated the most follow-on discussion. A user may also choose to filter comments based on the ratings of specific users within the community. For example, Alice may want to see only the comments that Bob rated highly. These are illustrative examples and many other embodiments are possible.

The system also supports a real-time commenting mode in which users who are jointly watching the same media at the same time can receive each other's comments in real-time.

Commentary Rendering

Comments can be rendered in a number of different modes.

Overlay Mode: comments are displayed at the exact time and, if applicable, the exact place where the commentator generated the original comment. Since each comment carries its creation time relative to the underlying media, media playback and commentary playback can be synchronized. Since each comment also contains spatial information relative to the underlying media, each comment can appear in the appropriate place. Locations can be resized to account for differences in the window-sizings of the original media and the comment-enriched media.

More than one comment may appear at the same time. Comments from different users may be represented with different visual markers including unique border colors, etc. Optionally, comments may be preceded by an audible tone to provide for both a visual and audible indication of a new comment.

Comments that were not encoded with spatial information can be displayed in a number of pre-configured ways within the overlay mode. One mode would display a banner overlayed onto the playing media placed at either the top or the bottom of the stream. Comments would be displayed within this banner. Comments would appear at their creation time, synchronized with the underlying media. Comments could be configured to persist on screen for a variable amount of time. For example, users could configure the comments to last for 10 seconds and then disappear. Comments appearing at roughly the same time could be stacked behind one another, or they could be separated vertically and resized so as to fill the entire banner.

Comments in this mode could also “accumulate” along the border rather than disappear after a period of time. The horizontal banner would be divided into a series of slots, the number of slots could be configured by the user. The first comment could occupy the, first, rightmost slot. The second comment would bump the first comment to the next slot on the left and occupy the first, rightmost slot. This way comments would accumulate and slowly make their way across the banner. Comments reaching the left-most slot of the banner would then be taken off the banner when the next comment appears.

Another visualization method includes comments moving along the banner from right to left dynamically, without the slotting arrangement. Comments could completely traverse the length of the banner during their user-defined lifetime. This visual effect would give the impression that comments were dynamic and fleeting. Users may specific the maximum number of comments to display at any one time.

Border Mode: Another visualization mode would have comments displayed outside the viewable area of the media. All of the discussed features for comment display would still apply with the exception that spatial information of comments would be ignored.

One aspect of the embodiments is the focus on flexibility of capture and display of commentary in the context of social media. The storage and management of the commentary by a cloud server that can be separate from the server where the original media is stored (and hence can be offered by a different company), the use of multiple network interfaces on the mobile device (e.g., wifi, 3G, WiMAX) to receive the streams and the use of a session management/synchnonization application on the phone to manage the rendering. Existing systems bundle the transport of the original media with the commentary or serialize their presentation (e.g., on YouTube you can either watch a video or read the comments people wrote about it but not both as an overlay at the same time). In the presently disclosed system and method, comments may be individually addressable, personalized, searchable, indexable, and/or tagged. Comments can be shared with a social network. Filtering techniques can be applied to make available comments more manageable. Comments are atomic units that can be delivered on their own. Multiple comments can be displayed across multiple commentators. Comments are synchronized. On-the-fly assembly of content and comments is featured. The embodiments provide a shared media experience. Comments can tracked back to the commentator (click-thrus, measure engagement, etc.). The system and method disclosed herein differ from other research projects which looked at adding commentary to email in a shared workgroup environment for purposes of facilitating group interactions. The system and method disclosed herein differs from those other research projects based at least on the scope of the present system and method (any commentary to any media) and the architecture of the present system and method (the entity that owns and provides the media can be different from the entity that manages the commentary—with the media and commentary coming together on the user screen for an immersive experience).

Some embodiments make use of mobile phones having multiple interfaces that allow multiple, independent information streams to be managed and delivered simultaneously to the phone and displayed as mashups. The embodiments generalize the idea to time and location shifting of media streams. The initial result achieved is the ability to manage, synchronize and display media and commentary information streams in a dynamic and flexible way. It was then recognized that the idea can be generalized to the management and co-display of media from any source to create a composite user experience of sound, text and video, all in an easy to use social media platform.

The creation, distribution and rendering of large scale “in context” and personalized commentary streams to a multi-interface mobile device in a Web 2.0 services environment is disclosed. Also disclosed are the application of time-shifting to media fragments that include original media and commentary left by users, the user generated content paradigm, the capturing of the commentary within the time line and the storing of the commentary on a server separate from the content, the mashup of the commentary on the user screen, and the possible use of multiple different and simultaneous network interfaces on the mobile device to deliver the multiple streams and then to synchronize them on the device.

As these and other variations and combinations of the features discussed above can be utilized without departing from the present invention as defined by the claims, the foregoing description of the one embodiments should be taken by way of illustration rather than by way of limitation of the invention as defined by the claims.

1. A system for processing commentary that is related to content, comprising:
at least one server for receiving commentary that is related to content and which is generated after generation of the content, and for generating data associating the commentary with the content by at least one of spatially linking the commentary to the content or temporally linking the commentary to the content.

2. The system as claimed in claim 1, further comprising a storage for storing the commentary and the data apart from the content.

3. The system as claimed in claim 1, wherein the metadata includes at least one of an identity of a person who created at least a portion of the commentary commentator, a time of day associated with creation of the commentary, a day of the week associated with creation of, or a tag descriptive of the commentary.

4. The system as claimed in claim 1, wherein the at least one server is used for receiving requests for the commentary.

5. The system as claimed in claim 1, wherein the at least one server is used for receiving requests for commentary and providing commentary in response to the requests.

6. The system as claimed in claim 1, wherein the at least one server is used for receiving a request for commentary, filtering the commentary according to criteria provided with the request to generate filtered commentary, and providing the filtered commentary in response to the request.

7. The system as claimed in claim 1, wherein the at least one server is used for receiving a relative location within the content for at least a portion of the commentary.

8. The system as claimed in claim 1, wherein the at least one server is used for receiving a user ID indicative of an identity of a person who created at least a portion of the commentary.

9. A method for processing commentary that is related to content, comprising:
receiving commentary that is related to content and which is generated after generation of the content; and
generating data associating the commentary with the content by at least one of spatially linking the commentary to the content or temporally linking the commentary to the content.

10. The method as claimed in claim 9, further comprising storing the commentary and the data apart from the content.

11. The method as claimed in claim 9, wherein the data includes at least one of an identity of a person who created at least a portion of the commentary commentator, a time of day associated with creation of the commentary, a day of the week associated with creation of, or a tag descriptive of the commentary.

12. The method as claimed in claim 9, further comprising receiving requests for the commentary.

13. The method as claimed in claim 9, further comprising providing at least a portion of the commentary in response to requests.

14. The method as claimed in claim 9, further comprising:
receiving a request for commentary;
filtering the commentary according to criteria provided with the request to generate filtered commentary; and
providing the filtered commentary in response to the request.

15. The method as claimed in claim 9, further comprising receiving a relative location within the content for at least a portion of the commentary.

16. The method as claimed in claim 9, further comprising receiving a user ID indicative of an identity of a person who created at least a portion of the commentary.

17. A device for receiving content and commentary and for presenting the received content and commentary to a user, comprising:
at least one interface for receiving the content from a first source and receiving the commentary from a second source; and
a processor for performing at least one of spatially linking the commentary to the content or temporally linking the commentary to the content.

18. The device as claimed in claim 17, wherein the at least one interface comprises a first interface for receiving the content from a first source, and second interface for receiving the commentary from a second source.

19. The device as claimed in claim 17, wherein the at least one interface is used for receiving data for at least one of spatially linking the commentary to the content or temporally linking the commentary to the content.

20. The device as claimed in claim 17, wherein the device presents the content with the commentary overlaying the content in a manner specified by the data.

21. The device as claimed in claim 17, further comprising at least one input for allowing the user to indicate that only comments that appear within a specified region of the content should be presented.

22. The device as claimed in claim 17, further comprising at least one input for accepting at least one of user-generated commentary concerning the content or user-generated feedback concerning the content.
